(19) United States
(12) Patent Application Publication
(10) Pub. No.: US 2008/0056788 A1
(43) Pub. Date: Mar. 6, 2008

(54) Image Recording Device and Image Recording Method

(75) Inventor: Hirokazu Okutsu, Kanagawa (JP)

Correspondence Address: TAIYO CORPORATION, 401 HOLLAND LANE, #407, ALEXANDRIA, VA, 22314, US

(73) Assignee: FUJIFILM CORPORATION, MINATO-KU, TOKYO (JP)

(21) Appl. No.: 11/663,845

(22) PCT Filed: Sep. 29, 2005
(86) PCT No.: PCT/JP05/18502

§ 371 Date: Mar. 27, 2007

(30) Foreign Application Priority Data
Sep. 30, 2004 (JP) 2004-288907

(51) Int. Cl. G03G 15/00

(52) U.S. Cl. 399/372

(57) ABSTRACT

An image recording device recording an image on an image-forming region of a strip-shaped flexible substrate stretched between a supply reel and a take-up reel, the device having: a stage section structured to suck the flexible substrate, and to be movable along a predetermined conveying path; an alignment section disposed above the conveying path of the stage section, and sensing at least an alignment mark of the flexible substrate; a correcting section which, based on the alignment mark sensed by the alignment section, corrects image data to be recorded on the image-forming region of the flexible substrate; and a recording section disposed above the conveying path of the stage section and at a downstream side, in a conveying direction of the flexible substrate, of the alignment section, the recording section recording, on the image-forming region of the flexible substrate, the image data corrected.

### BACKGROUND OF THE INVENTION

1. Field of the Invention

The present invention relates to an image recording device and an image recording method which record an image on an image-forming region of a strip-shaped flexible substrate stretched between a supply reel and a take-up reel.

2. Description of the Related Art

Conventional image recording devices have been known which, while feeding-out a flexible substrate which is wound in the form of a roll, record images on image-forming regions thereof. Such an image recording device has a stage member which is disposed between a loader and an unloader, and which temporarily fixes the flexible substrate. The loader has a supply reel on which is set the flexible substrate which is wound in the form of a roll. The unloader has a take-up reel which takes-up the flexible substrate, on which images have been recorded, in the form of a roll.

Accordingly, the flexible substrate is placed on the stage member in a state of being stretched between the loader and the unloader, and, on the stage member, an image is recorded in the image-forming region by an exposure section. Then, when recording of the image is completed, the flexible substrate is conveyed by a predetermined amount due to the driving of the loader and the unloader. The next image-forming region is placed on and fixed to the stage member, and is exposed. By repeating these operations successively, images are recorded on the image-forming regions of the flexible substrate which is wound in the form of a roll.

Marks for positioning (hereinafter called “alignment marks”), which demarcate the image-forming regions and which are for enabling position correction with respect to the exposure section, are provided at the flexible substrate. Namely, a camera for reading the alignment marks is provided at the image recording device. On the basis of the position data of the alignment marks read by the camera, the recording position of the image data with respect to the flexible substrate (the image-forming region) is corrected (see, for example, Japanese Patent Application Laid-Open (JP-A) No. 2000-227661).

In an image recording device of such a structure, by reading the alignment marks of the flexible substrate which is placed on and fixed to the stage member, positional correction can be carried out with respect to the positional offset (skewing) in the direction orthogonal to the conveying direction. (Hereinafter, the direction orthogonal to the conveying direction will be referred to as the “main scanning direction” or the “transverse direction”.) However, correction cannot be carried out with respect to the positional offset (elongation) in the conveying direction of the flexible substrate (the subscanning direction).

Namely, the flexible substrate has elasticity of a certain extent, and is stretched in a state in which tension of a certain extent is applied thereto by the loader and the unloader. Therefore, the flexible substrate is conveyed in a state in which it is elongated slightly in the conveying direction (the subscanning direction). Accordingly, if an image is formed (recorded) for this elongated state, the image may deform when the tension is eliminated.

### SUMMARY OF THE INVENTION

In order to achieve the above-described object, an image recording device of a first aspect of the present invention is an image recording device recording an image on an image-forming region of a strip-shaped flexible substrate stretched between a supply reel and a take-up reel, the device including: a stage section structured so as to be able to suction the flexible substrate, and so as to be movable along a predetermined conveying path; an alignment section disposed above the conveying path of the stage section, and sensing at least an alignment mark of the flexible substrate; a correcting section which, on the basis of the alignment mark sensed by the alignment section, corrects image data to be recorded on the image-forming region of the flexible substrate; and a recording section disposed above the conveying path of the stage section and at a downstream side, in a conveying direction of the flexible substrate, of the alignment section, the recording section recording, on the image-forming region of the flexible substrate, the image data corrected by the correcting section.

In accordance with the first aspect of the present invention, because the stage member sucks and conveys the flexible substrate, highly accurate conveying, in which the occurrence of skewing and wrinkles and the like is prevented, can be realized. Accordingly, the desired image can be accurately recorded on the flexible substrate.

An image recording device of a second aspect of the present invention is the image recording device of the first aspect, wherein an interval between the alignment section and the recording section is greater than or equal to a length of one image-forming region in the conveying direction of the flexible substrate.

In accordance with the second aspect of the present invention, for one image-forming region, alignment processing can be completed before image recording processing. Accordingly, the image data can be corrected accurately.

An image recording device of a third aspect of the present invention is the image recording device of the first aspect, wherein an interval between the alignment section and the recording section is less than a length of one image-forming region in the conveying direction of the flexible substrate, and after the alignment section senses the alignment mark, the stage section moves a predetermined distance in a direction opposite to the conveying direction, and leading-end-positioning of the stage section with respect to the recording section is carried out.

In accordance with the third aspect of the present invention, for one image-forming region, alignment processing can be completed before image recording processing. Accordingly, the image data can be corrected accurately. Further, because the alignment section and the recording section can be disposed as close as possible to one another, the length of the image recording device in the conveying direction of the flexible substrate can be reduced. Namely, the image recording device can be structured compactly.

An image recording device of a fourth aspect of the present invention is the image recording device of one of first through third aspects, wherein the correcting section computes a correction amount at least with respect to the conveying direction of the flexible substrate.

In accordance with the fourth aspect of the present invention, alignment processing can be carried out with respect to positional offset in the conveying direction of the flexible substrate (i.e., elongation). Accordingly, an image can be accurately recorded on the flexible substrate.

An image recording device of a fifth aspect of the present invention is the image recording device of the first aspect, wherein the flexible substrate is conveyed-in and discharged-out with the image-forming region of the flexible substrate suctioned to the stage section.

In accordance with the fifth aspect of the present invention, the flexible substrate is conveyed-in and discharged-out with the image-forming region thereof sucked to the stage section. Accordingly, there is no need for a separate mechanism or the like for conveying-in and discharging-out the flexible substrate.

An image recording device of a sixth aspect of the present invention is the image recording device of the first aspect, wherein the recording section has an exposure head which exposes the flexible substrate and records the image data.

An image recording device of a seventh aspect of the present invention is the image recording device of sixth aspect, wherein the exposure head irradiates a light beam, which is modulated on the basis of the image data, and exposes the flexible substrate.

An image recording method of an eighth aspect of the present invention is an image recording method recording an image on an image-forming region of a strip-shaped flexible substrate stretched between a supply reel and a take-up reel, the method including: moving, along a predetermined conveying path, a stage section which suctions the flexible substrate; sensing, by an alignment section, at least an alignment mark of the flexible substrate; on the basis of the sensed alignment mark, correcting, by a correcting section, image data to be recorded on the image-forming region of the flexible substrate; and recording, by a recording section, corrected image data on the image-forming region of the flexible substrate.

In accordance with the eighth aspect of the present invention, because the stage member sucks and conveys the flexible substrate, highly accurate conveying, in which the occurrence of skewing and wrinkles and the like is prevented, can be realized. Accordingly, the desired image can be accurately recorded on the flexible substrate.

An image recording method of a ninth aspect of the present invention is the image recording method of the eighth aspect, wherein an interval between the alignment section and the recording section is greater than or equal to a length of one image-forming region in a conveying direction of the flexible substrate, and after the alignment section senses the alignment mark, the stage section stops once, the correcting section computes a correction amount, and image recording is started while the stage section moves to the recording section.

In accordance with the ninth aspect of the present invention, for one image-forming region, alignment processing can be completed before image recording processing. Accordingly, the image data can be corrected accurately.

An image recording method of a tenth aspect of the present invention is the image recording method of the eighth aspect, wherein an interval between the alignment section and the recording section is less than a length of one image-forming region in a conveying direction of the flexible substrate, and after the alignment section senses the alignment mark, the stage section moves a predetermined distance in a direction opposite to the conveying direction, leading-end-positioning of the stage section with respect to the recording section is carried out, the correcting section computes a correction amount, and image recording is started while the stage section moves to the recording section.

In accordance with the tenth aspect of the present invention, for one image-forming region, alignment processing can be completed before image recording processing. Accordingly, the image data can be corrected accurately. Further, because the alignment section and the recording section can be disposed as close as possible to one another, the length of the image recording device in the conveying direction of the flexible substrate can be reduced. Namely, the image recording device can be structured compactly. Moreover, because the correcting section computes the correction amount while the stage section is moving, there are no problems such as the tact time for processing one image-forming region increasing.

An image recording method of an eleventh aspect of the present invention is the image recording method of one of the eighth through tenth aspects, wherein the correcting section computes a correction amount at least with respect to a conveying direction of the flexible substrate.

In accordance with the eleventh aspect of the present invention, alignment processing can be carried out with respect to positional offset in the conveying direction of the flexible substrate (i.e., elongation). Accordingly, an image can be accurately recorded on the flexible substrate.

An image recording method of a twelfth aspect of the present invention is the image recording method of the eighth aspect, wherein the flexible substrate is conveyed-in and discharged-out with the image-forming region of the flexible substrate suctioned to the stage section.

In accordance with the twelfth aspect of the present invention, the flexible substrate is conveyed-in and discharged-out with the image-forming region thereof sucked to the stage section. Accordingly, there is no need for a separate mechanism or the like for conveying-in and discharging-out the flexible substrate.

An image recording method of a thirteenth aspect of the present invention is the image recording method of the eighth aspect, wherein the recording section has an exposure head which exposes the flexible substrate and records the image data.

An image recording method of a fourteenth aspect of the present invention is the image recording method of the thirteenth aspect, wherein the exposure head irradiates a light beam, which is modulated on the basis of the image data, and exposes the flexible substrate.

In any case, in accordance with the present invention, there are provided an image recording device and an image recording method which can accurately record an image on a flexible substrate.

### BRIEF DESCRIPTION OF THE DRAWINGS

FIG. 1 is a schematic perspective view of an image recording device.

FIG. 2 is a schematic side view of the image recording device.

FIG. 3A is a schematic plan view showing exposure regions of exposure heads.

FIG. 3B is a schematic plan view showing an arrangement pattern of the exposure heads.

FIG. 4 is a schematic perspective view of an alignment section.

FIG. 5A is a schematic perspective view of a PD sensor when a cover is open.

FIG. 5B is a schematic perspective view of the PD sensor when the cover is closed.

FIG. 6A is a schematic side view showing a state in which the exposure heads are inspected by the PD sensor.

FIG. 6B is a schematic side view showing a state in which a flexible substrate is set at an unloader by a stage member.

FIGS. 7A through 7E are schematic side views for explanation of processes of forming an image on the flexible substrate.

FIG. 8 is a schematic perspective view showing a modified example of the image recording device.

FIG. 9 is a schematic side view showing the modified example of the image recording device.

FIGS. 10A through 10F are schematic side views for explanation of processes of the modified example forming an image on the flexible substrate.

FIG. 11 is a block diagram showing a control system which detects alignment marks.

FIG. 12A is a schematic plan view showing the flexible substrate before being stretched between a loader and the unloader.

FIG. 12B is a schematic plan view showing the flexible substrate after being stretched between the loader and the unloader.

### DETAILED DESCRIPTION OF THE INVENTION

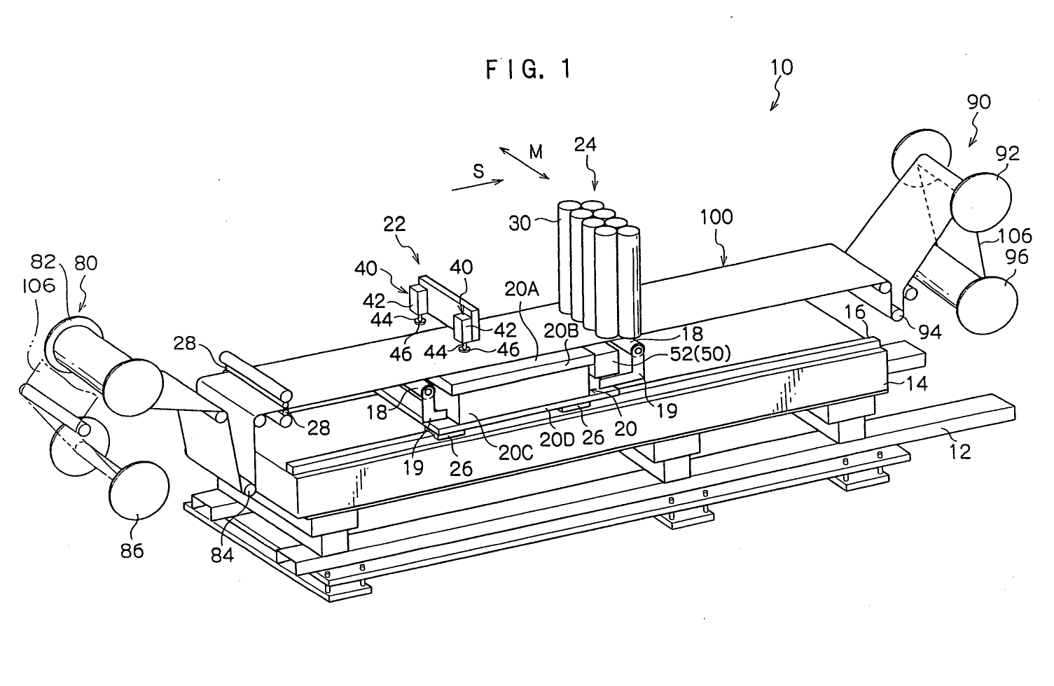

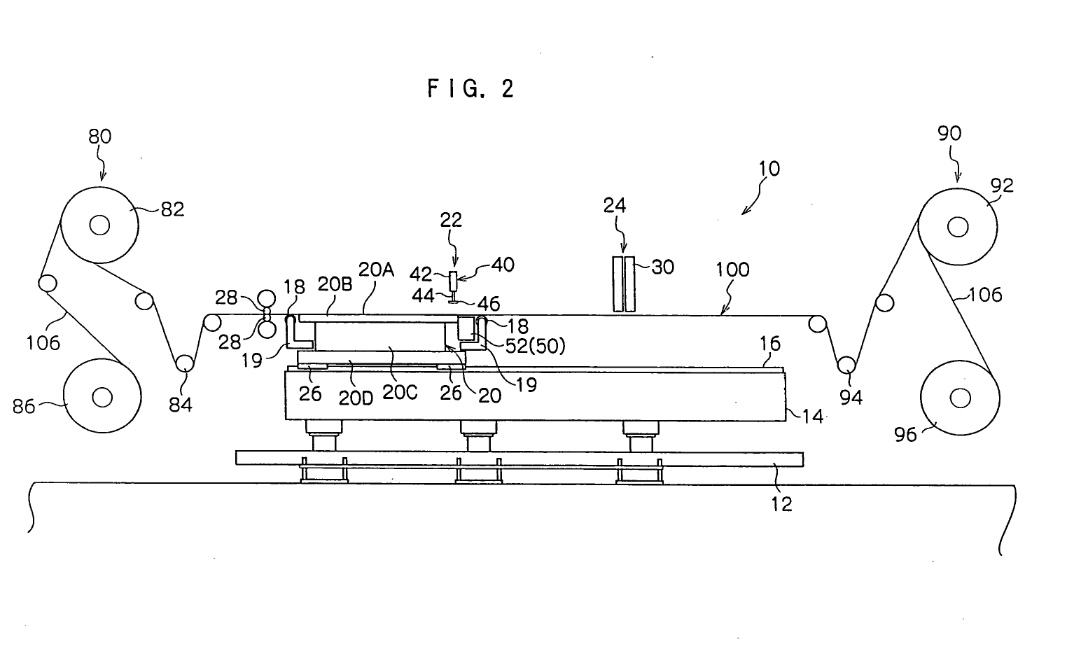

A preferred embodiment of the present invention will be described in detail hereinafter on the basis of the example illustrated in the drawings. FIG. 1 is a schematic perspective view of an image recording device 10 relating to the present invention, and FIG. 2 is a schematic side view thereof. Note that, in FIG. 1, arrow M is a main scanning direction (transverse direction), and arrow S is a subscanning direction (conveying direction). Further the direction opposite the subscanning direction (conveying direction) is the return direction.

[Structure of Flexible Substrate]

As shown in FIGS. 1 and 2, the recording medium, which is the object of the image recording device 10 relating to the present invention, is a flexible substrate 100 which is continuous in a strip-shaped form. In the flexible substrate 100, a metal thin film layer of copper foil or the like is formed on a flexible, film-like, insulating layer, and the metal thin film layer is laminated by a dry film resist. The flexible substrate 100 is wound in the form of a roll and set at a loader 80. Note that the flexible substrate 100 may be any of various types of flexible recording media such as a substrate for a liquid crystal display, a filter, or the like.

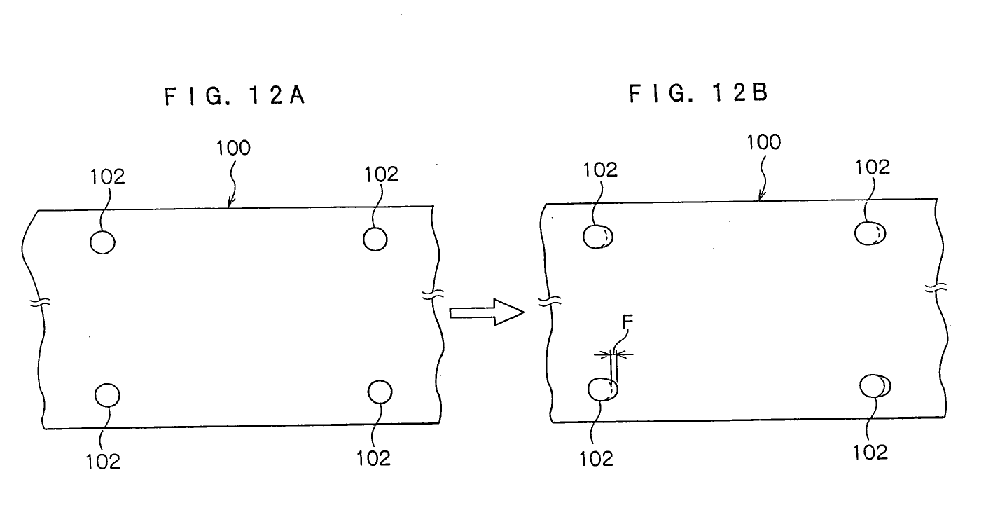

There are various types of the flexible substrate 100, such as a single-sided circuit in which a wiring pattern is formed only on one surface, a double-sided circuit in which wiring patterns are formed on both surfaces, a multilayer circuit in which a layer at which a wiring pattern is formed is laminated at the outer side of a double-sided circuit, and the like. Further, a plurality of image-forming regions (not shown) are set in advance on the exposure surface of the flexible substrate 100. Plural groups of alignment marks 102 (see FIG. 12A), which correspond to the respective image-forming regions (and which are references for demarcating the respective image-forming regions), are formed at predetermined positions of the flexible substrate 100.

[Structure of Image Recording Device]

As shown in FIGS. 1 and 2, the image recording device 10 is disposed between the loader 80 and an unloader 90. The loader 80 has a supply reel 82 which holds the unexposed flexible substrate 100 wound in the form of a roll, such that the flexible substrate 100 can be drawn-out therefrom. The unloader 90 has a take-up reel 92 which takes-up, in the form of a roll, the exposed flexible substrate 100 on which images have been recorded. Dancer rollers 84, 94, and the like, which adjust the tension which is applied to the flexible substrate 100, are disposed between the loader 80 and the image recording device 10 and between the unloader 90 and the image recording device 10.

The image recording device 10 has: a supporting stand 14 of a predetermined thickness, whose top surface is substantially shaped as a rectangle whose longitudinal direction is the subscanning direction (the conveying direction); a stage member 20 movably supported by a pair of guide rails 16 which are disposed on the supporting stand 14 parallel to the subscanning direction (the conveying direction), the stage member 20 sucking and conveying, per image-forming region, the flexible substrate 100 which is stretched between the loader 80 and the unloader 90; an alignment section 22 sensing the alignment marks 102 of the flexible substrate 100 which is sucked to and conveyed by the stage member 20; an exposure section 24 exposing the image-forming region of the flexible substrate 100 which is sucked to and conveyed by the stage member 20; and the like.

Vibration-proofing rubbers (not shown) or the like are disposed between a frame 12 disposed horizontally on the floor and the supporting stand 14 disposed on the frame 12, such that vibrations from the floor are cut-off. Further, a collecting reel 86, which collects a protective film 106 which was covering the flexible substrate 100, is disposed at the loader 80. A feed-out reel 96, which feeds-out the protective film 106 which is to cover the flexible substrate 100, is disposed at the unloader 90.

As described above, the pair of guide rails 16 are disposed on the top surface portion of the supporting stand 14, parallel to the subscanning direction (the conveying direction), and the stage member 20 is disposed on the guide rails 16 so as to be reciprocatingly movable. The stage member 20 has: a supporting body 20B at which the configuration of a top surface (hereinafter “stage surface”) 20A thereof substantially is a rectangle whose longitudinal direction is the subscanning direction (the conveying direction); a raising/lowering mechanism 20C which raises and lowers the supporting body 20B; and a base 20D which supports the raising/lowering mechanism 20C. A guide member 26, which is substantially shaped as an upside-down “U” in sectional view and which extends rectilinearly along the subscanning direction (the conveying direction), is mounted to each of the four corners of the bottom surface of the base 20D. The guide members 26 are slidably fit-together with the guide rails 16.

The structure which reciprocatingly moves the stage member 20 along the guide rails 16 is arbitrary. For example, a structure can be employed in which a tubular member (not shown), with which is screwed together a ball screw (not shown) disposed between the guide rails 16, is fixed at the center of the bottom surface of the base 20D, and a motor (not shown) is joined to one end of the ball screw, or the like. In accordance therewith, due to the ball screw being rotated in forward and reverse directions due to the rotational driving force of the motor, the stage member 20 can be moved reciprocatingly along the guide rails 16 on the supporting stand 14 via the tubular member.

An arbitrary structure can be employed for the structure of the raising/lowering mechanism 20C as well. For example, a structure which raises and lowers by an air cylinder (not shown) or the like can be used. Moreover, a large number of small holes (not shown) are formed in the stage surface 20A of the stage member 20, and the interior of the supporting body 20B which includes the stage surface 20A is hollow. The interior of the supporting body 20B is piped so as to become negative pressure. Namely, one end of a pipe (not shown), which is structured by a flexible tube, is connected to the supporting body 20B of the stage member 20 so as to not impede movement of the stage member 20, and the other end of the pipe is connected to a vacuum pump (not shown).

A switching valve (not illustrated), which is operated by an electric means, is disposed midway along the pipe. The interior of the supporting body 20B of the stage member 20 is set in a negative pressure state and the negative pressure state is cancelled, by this switching valve. In this way, the flexible substrate 100 is sucked to the stage surface 20A of the stage member 20, and the sucking thereof is released.

Guide rollers 18, which support the flexible substrate 100, for which sucking by the stage member 20 has been released, from the reverse surface (bottom surface) side of the flexible substrate 100, are disposed at the subscanning direction side (conveying direction side) and the return direction side of the stage member 20, so as to be parallel to the main scanning direction (the transverse direction). The guide rollers 18 are supported so as to be freely rotatable at brackets 19 which are mounted to the both end portions of the subscanning direction (conveying direction) side and the return direction side of the base 20D, and move together with the stage member 20. The heights of the guide rollers 18 do not change.

Cleaning rollers 28, which clean at least the exposure surface (the image-forming regions) of the flexible substrate 100, are disposed parallel to the main scanning direction (the transverse direction) between the supporting stand 14 and the dancer roller 84. The cleaning rollers 28 are structured so as to slidingly contact the flexible substrate 100 and so as to move away from the flexible substrate 100 at predetermined times.

The exposure section 24 has a plurality of exposure heads 30. Each exposure head 30 is supported, so as to face downward, at a supporting member (not shown) provided above the substantial center in the subscanning direction (the conveying direction) of the supporting stand 14. When the flexible substrate 100 passes by an exposure position directly beneath the supporting member, plural laser beams, which are modulated on the basis of image data, are illuminated from above onto the exposure surface (the image-forming region) of the flexible substrate 100, such that an image (a latent image) is formed (recorded) on the exposure surface (the image-forming region).

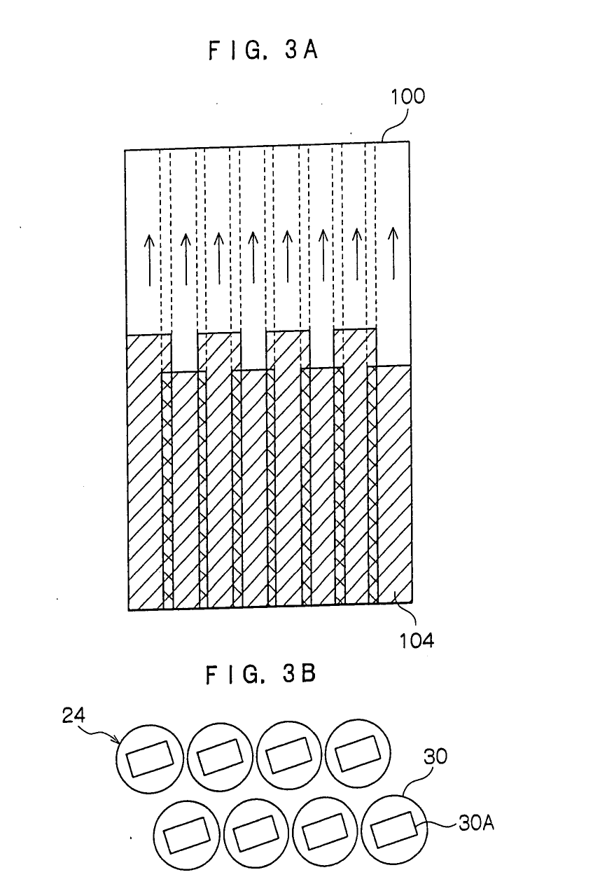

As shown in FIG. 3B, the exposure heads 30 are disposed along the transverse direction of the supporting stand 14 (the main scanning direction) in plural lines and plural columns, e.g., in the form of a matrix of two lines and four columns, and are offset from one another so as to be staggered as seen in plan view. Accordingly, exposed regions 104 such as shown in FIG. 3A are formed.

Namely, the exposure heads 30 are lined-up in the main scanning direction (the transverse direction) which is orthogonal to the subscanning direction (the conveying direction) in which the stage member 20 moves. An exposure area 30A of the exposure head 30 is a rectangle whose short side is the subscanning direction (the conveying direction), and is inclined at a predetermined angle with respect to the subscanning direction (the conveying direction). Accordingly, as the stage member 20 moves, the strip-shaped exposed region 104 is formed by each exposure head 30 on the flexible substrate 100.

A light source unit (not shown) is disposed at a place at which it cannot impede the movement of the stage member 20. A plurality of laser (semiconductor laser) generating devices (not shown) are housed in the light source unit. The lights exiting from the laser generating devices are guided, via optical fibers (not shown), to the respective exposure heads 30.

At each exposure head 30, the light beam which is guided thereto and made incident therein by the optical fiber, is controlled in units of dots by an unillustrated digital micromirror device (hereinafter, “DMD”) which is a spatial light modulator, and the exposure head 30 exposes a dot pattern on the flexible substrate 100. The density of one pixel is expressed by using a plurality of dot patterns.

The DMD is a mirror device in which a large number of micromirrors, at which the angles of the reflecting surfaces thereof are varied in accordance with control signals, are lined-up two-dimensionally in plural lines and plural columns on a semiconductor substrate formed of silicon or the like. Accordingly, when a single light is irradiated onto the DMD, plural lights can be modulated and controlled independently in accordance with the resolution. Namely, light beams (laser beams) can be modulated in accordance with image data.

Generally, the spatial light modulator such as the DMD or the like is arranged in the form of a matrix in which the lined-up direction of the respective lines and the lined-up direction of the respective columns are orthogonal to one another. However, when the DMD is disposed at an incline with respect to the subscanning direction (the conveying direction), the intervals between the scan lines at the time of scanning become more narrow, and the resolution can be increased. Namely, by tilting the two-dimensionally arranged dot pattern with respect to the subscanning direction (the conveying direction), the respective dots which are lined-up in the subscanning direction (the conveying direction) pass through between the dots which are lined-up in the main scanning direction (the transverse direction) which intersects the subscanning direction (the conveying direction). Accordingly, the substantial pitch between dots can be narrowed, and a higher resolution can be realized.

The alignment section 22 is disposed in a state of being supported by a supporting member which is similar to that mentioned above, at a predetermined position at the upstream side, in the conveying direction of the flexible substrate 100, of the exposure section 24. By reading the plural groups of alignment marks 102 (see FIG. 12A) provided at predetermined positions of the flexible substrate 100, the alignment section 22 demarcates the image-forming regions, and computes position correction data of the flexible substrate 100, and in particular, the positional offset amount in the conveying direction (the ratio of expansion/contraction due to elongation F, see FIG. 12B).

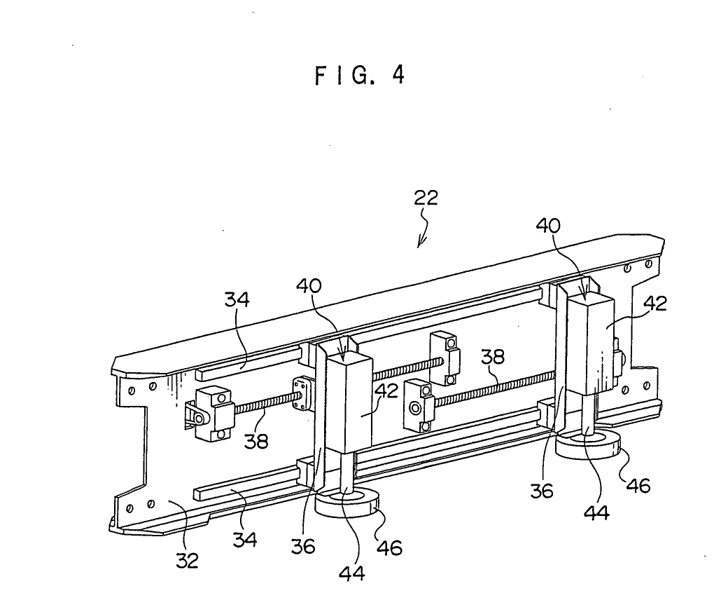

As shown in FIG. 4, the alignment section 22 has a base plate 32 which is fixed to the supporting member; a pair of guide rails 34 which are disposed at the base plate 32 and are parallel to the main scanning direction (the transverse direction); a plurality of (e.g., two) brackets 36 mounted so as to be slidable in the main scanning direction (the transverse direction) along the guide rails 34; and a plurality of (e.g., two) cameras 40 supported at the respective brackets 36.

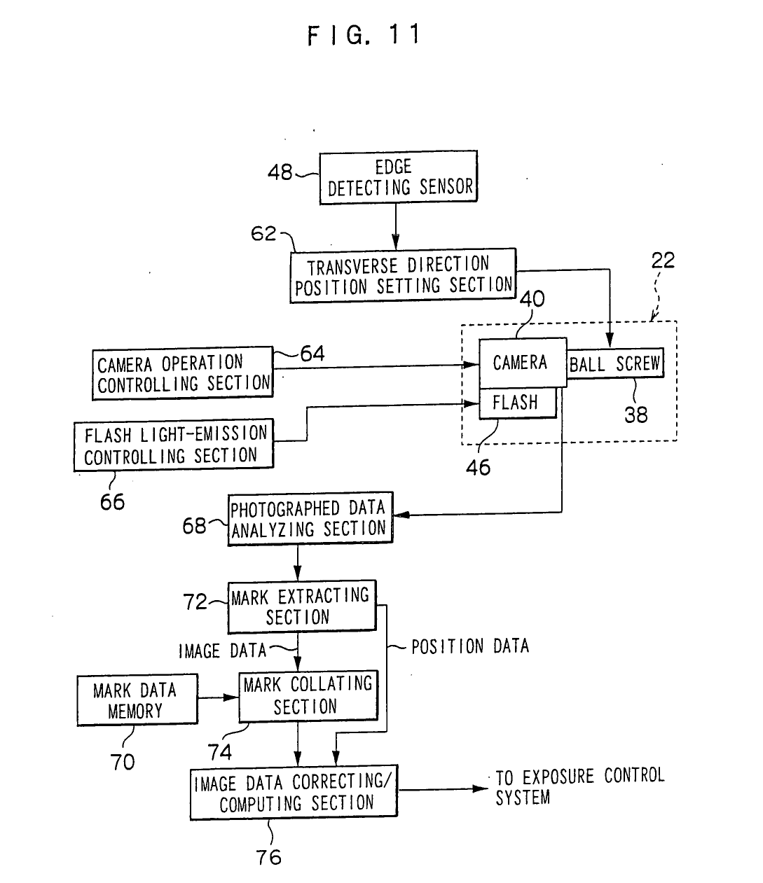

The bracket 36 can move reciprocatingly in the main scanning direction (the transverse direction) along the guide rails 34 due to the forward and reverse rotational driving of a ball screw 38 for example. A lens 44 is provided at the bottom surface of a main body portion 42 of the camera 40. A ring-shaped flash (LED flash) 46, whose light-emitting time each one time is extremely short, is mounted to the projecting distal end portion of the lens 44. The sensitivity of the camera 40 is adjusted by a camera operation controlling section 64 shown in FIG. 11, such that image pickup is possible only at times when the flash 46 emits light.

Accordingly, when the stage member 20 passes by the image pickup position which is positioned on the optical axis of each camera 40, the flash 46 is made to emit light at a predetermined time by a flash light-emission controlling section 66 shown in FIG. 11. The image pickup range, which includes the alignment mark 102, on the flexible substrate 100 can thereby be picked-up by the camera 40. Namely, the light from the flash 46 is illuminated onto the flexible substrate 100 on the stage member 20. Due to the light reflected therefrom being inputted to the main body portion 42 via the lens 44, the alignment mark 102 on the flexible substrate 100 is photographed.

It is preferable that the stage member 20 be temporarily stopped at the times when the alignment marks 102 are photographed. In accordance with such a structure, it is possible to eliminate configurational errors of the alignment marks 102 at the time of photographing while the stage member 20 is being moved, and it is possible to accurately compute only the positional offset amount in the conveying direction of the flexible substrate 100, i.e., only the ratio of the expansion/contraction due to the elongation F. Of course, detection of the alignment marks 102 may be carried out while the stage member 20 is being moved.

Each camera 40 has, as the image pickup range thereof, a different range along the transverse direction of the flexible substrate 100 (the main scanning direction). Due to one transverse direction (main scanning direction) end portion (edge) of the flexible substrate 100 which is the object of image pickup being detected by an edge detecting sensor 48 which will be described later, the positions of the plural groups of alignment marks 102 can be estimated. On the basis of this estimated data, the driving of the ball screws 38 is controlled by a transverse direction position setting section 62 shown in FIG. 11, so that the cameras 40 are disposed at predetermined positions in advance.

As shown in FIG. 11, the image recording device 10 has: a photographed data analyzing section 68 which identifies the alignment marks 102 photographed by the cameras 40; an alignment mark extracting section 72 converting the analog image data of the photographed alignment marks 102 into digital image data; an alignment mark data memory 70 storing, in advance, alignment marks which are references; an alignment mark collating section 74 comparing the alignment marks 102 extracted by the alignment mark extracting section 72 and the reference alignment marks stored in the alignment mark data memory 70; and an image data correcting/computing section 76 computing position correction data from comparison data detected by the alignment mark collating section 74 and position data obtained by the alignment mark extracting section 72.

Accordingly, the alignment marks 102, which are photographed by the cameras 40 as the stage member 20 moves in the subscanning direction (the conveying direction) and passes by the alignment section 22, and which are identified by the photographed data analyzing section 68, are converted into digital image data by the alignment mark extracting section 72, and are compared with the reference alignment marks by the alignment mark collating section 74.

Then, the position correction data with respect to the elongation F in the conveying direction as shown in FIG. 12B, and the skewing, and the like, is computed by the image data correcting/computing section 76. Note that the stage member 20 may be structured so as to temporarily stop when having passed by the alignment section 22 (i.e., when photographing of the alignment marks 102 of the plural groups corresponding to one image-forming region is completed), such that the aforementioned position correction data is computed during that time.

When the position correction data of the ratio of the expansion/contraction and the like is computed in this way, correction based on this position correction data is carried out on the image data of the time of carrying out exposure by the exposure heads 30. Then, as the stage member 20 moves in the subscanning direction (the conveying direction), light beams, which are modulated on the basis of this corrected image data, are irradiated by the exposure heads 30 onto the image-forming region of the flexible substrate 100. In this way, the desired image can be accurately formed (recorded) on the image-forming region of the flexible substrate 100.

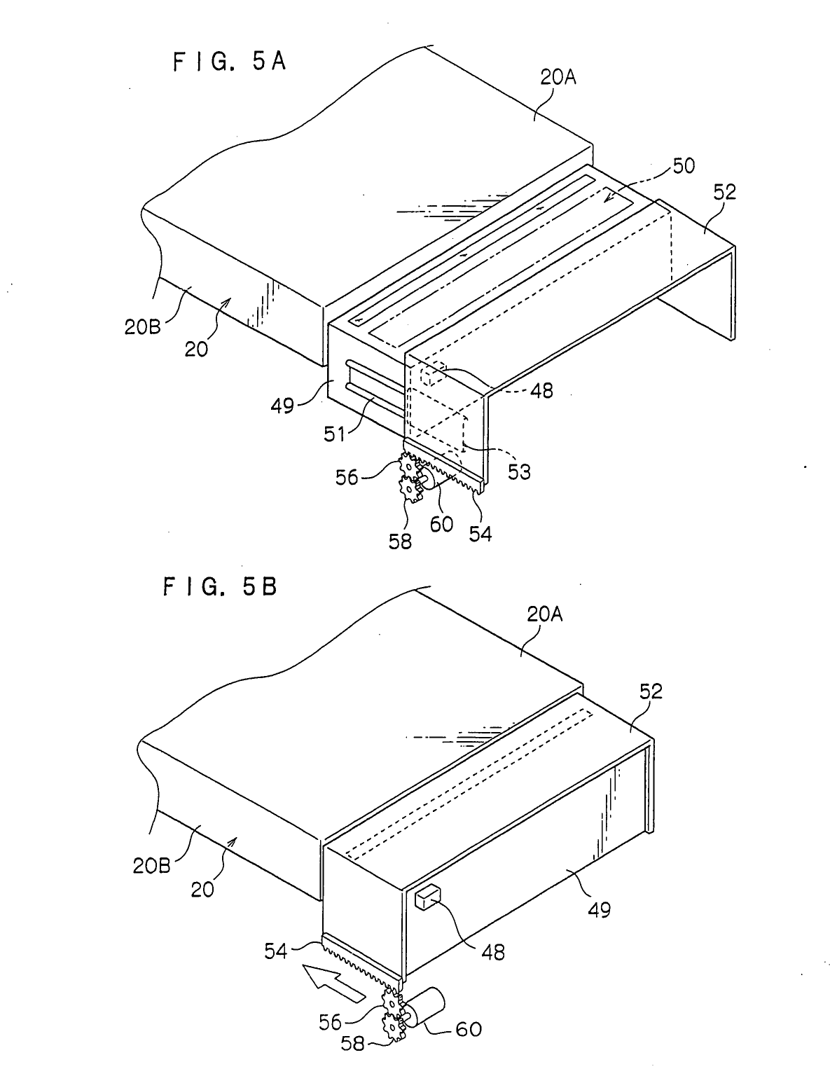

As shown in FIGS. 5A and 5B, a Power Detector sensor (hereinafter called “PD sensor”) 50, which inspects the light amounts of the exposure heads 30 and the junctures and the like before the flexible substrate 100 is exposed (i.e., before the image is recorded on the flexible substrate 100), is provided integrally with the supporting body 20B via a housing 49 at the subscanning direction (conveying direction) side of the stage member 20.

As described above, the exposure heads 30 are disposed in a substantial matrix form of, for example, two lines and four columns. Therefore, the PD sensor 50 inspects in advance whether gaps (portions that will be unexposed) exist at boundary portions (junctures) between the exposure heads 30. Then, the exposure amounts, the beam positions, and the like of the exposure heads 30 are adjusted on the basis of the results of this inspection. Note that the PD sensor 50 is covered by a cover 52 when not in use, i.e., when the flexible substrate 100 is exposed (when an image is exposed onto the flexible substrate 100). The cover 52 is structured so as to be opened and closed automatically, but the structure thereof is arbitrary.

For example, as shown in FIGS. 5A and 5B, guide rails 51 are disposed at the both outer side surfaces of the housing 49. Guide rails 53, which fit-together with the guide rails 51 from the vertical direction, are provided at the both inner side surfaces of the cover 52. At the bottom portion of one side wall of the cover 52, a rack 54 is provided, and a pinion 56 which meshes with the rack 54 is provided. Moreover, a motor 60, to whose driving shaft is fixed a gear 58 which meshes with the pinion 56, is provided. With such a structure, the cover 52 can slide in the subscanning direction (the conveying direction) and the return direction due to the forward and reverse rotational driving of the motor 60.

As shown in FIGS. 2, 5A and 5B, the PD sensor 50 is disposed so as to be positioned slightly lower than the stage surface 20A of the stage member 20 as seen in side view. Also when the PD sensor 50 is covered by the cover 52, the cover 52 is at a position which is slightly lower than the stage surface 20A as seen in side view. (The cover 52 may be flush with the stage surface 20A, but is preferably at a position which is slightly lower than the stage surface 20A.) In this way, the PD sensor 50 (the cover 52) does not contact the flexible substrate 100. Further, in the image recording device 10, the edge detecting sensor 48, which detects a transverse direction (main scanning direction) end portion (edge) of the flexible substrate 100, is provided at an appropriate position on the line of conveying of the flexible substrate 100.

In accordance with the results of sensing of the edge detecting sensor 48, the rotating/driving of the ball screws 38 is controlled via the transverse direction position setting section 62 (see FIG. 11), and the positions of the cameras 40 at the alignment section 22 are changed. Note that the edge detecting sensor 48 is disposed in a vicinity of the PD sensor 50, and due to the PD sensor 50 being covered by the cover 52, the edge detecting sensor 48 can detect the edge of the flexible substrate 100.

[Operation of Image Recording Device]

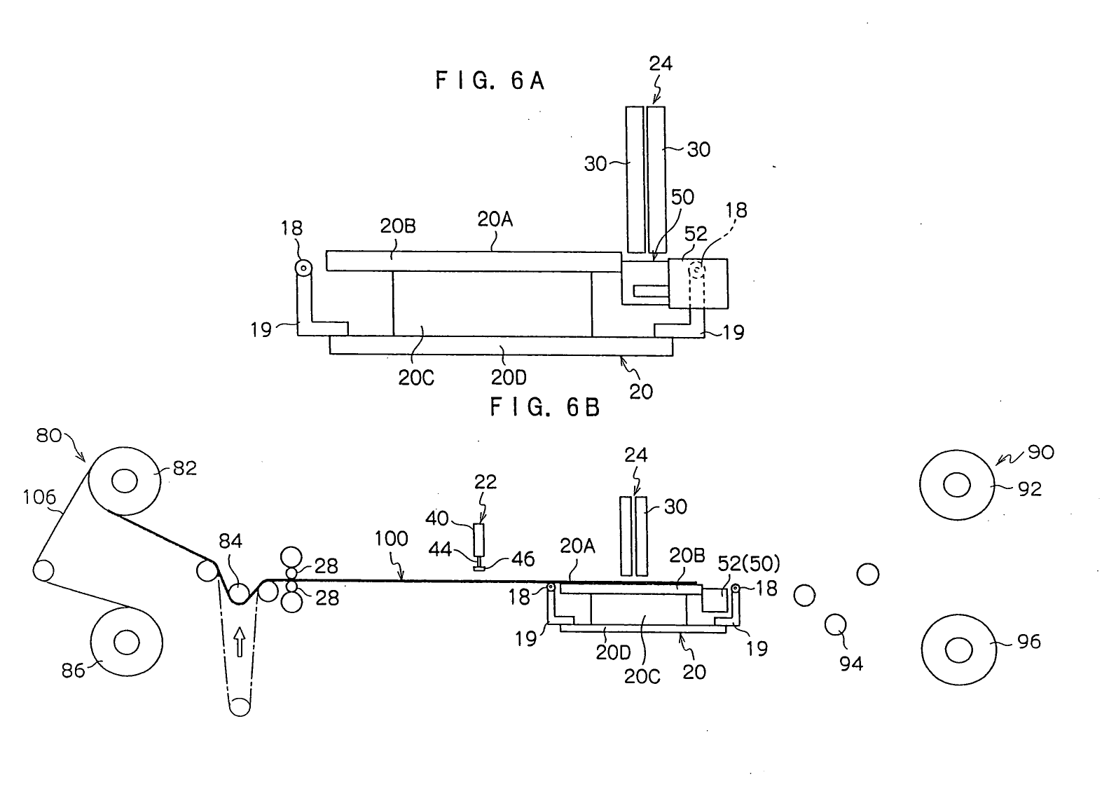

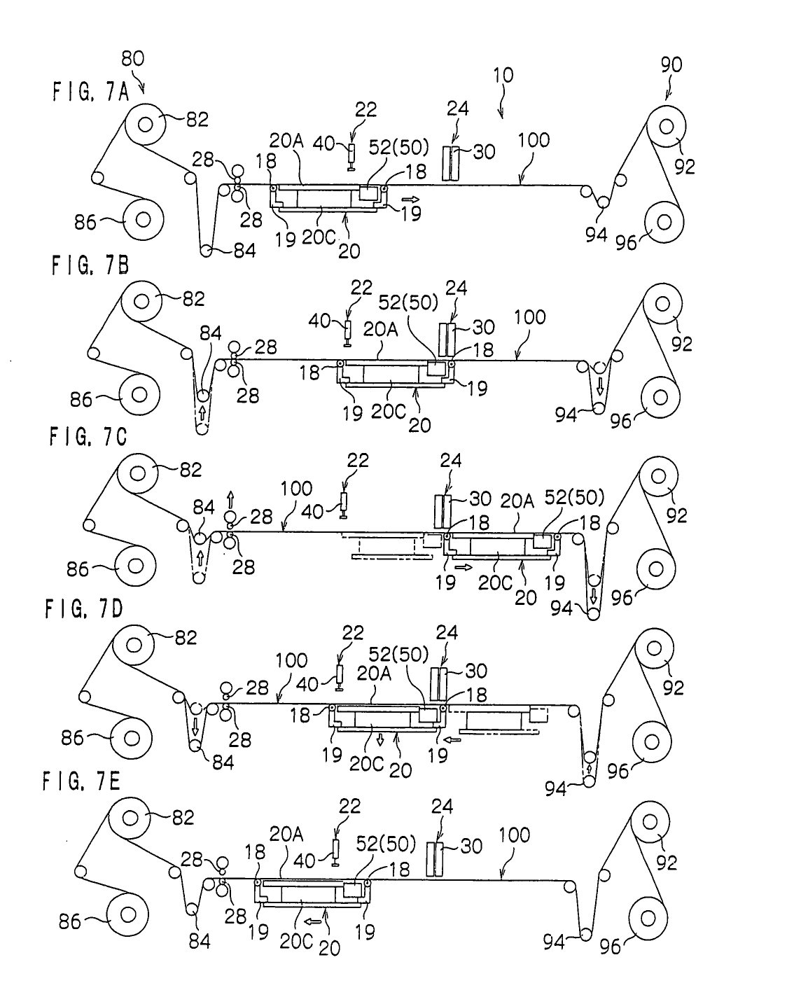

Next, the operation of the image recording device 10, which has the above-described structure, will be described mainly on the basis of FIGS. 6A and 6B, and FIGS. 7A through 7E. First, as shown in FIG. 6A, the supporting body 20B is raised by the raising/lowering mechanism 20C, and the PD sensor 50 is disposed at the exposure position of the exposure heads 30 with respect to the flexible substrate 100. The height by which the supporting body 20B (the stage surface 20A) is raised at this time is equal to the difference in the heights of the stage surface 20A and the PD sensor 50.

Then, as shown in FIG. 5A, the motor 60 is rotated, and the cover 52 is slid in the subscanning direction (conveying direction) via the gear 58, the pinion 56, and the rack 54, so as to open the PD sensor 50. In this way, the light amounts and junctures of the exposure heads 30 are inspected, and, if necessary, are adjusted. Note that, when the cover 52 is open, the height thereof is slightly higher than the height of the guide roller 18. Therefore, the cover 52 slides above the guide roller 18 and does not interfere with the guide roller 18.

When the inspection and adjustment of the exposure heads 30 is completed, as shown in FIG. 5B, the motor 60 is rotated reversely, and the cover 52 is slid in the return direction. Then, due to the raising/lowering mechanism 20C lowering the supporting body 20B, the stage surface 20A is lowered. Next, as shown in FIG. 6B, the leading end of the flexible substrate 100, which is in the form of a roll and which is set at the supply reel 82 of the loader 80, is trained about the dancer roller 84, is passed between the cleaning rollers 28, and is sucked to the stage surface 20A of the stage member 20 by the suctioning of air from the small holes.

Thereafter, when the stage member 20 is moved in the subscanning direction (conveying direction) along the guide rails 16 and is stopped at a predetermined position, the suctioning of air from the small holes is cancelled. The leading end of the flexible substrate 100 is peeled off from the stage surface 20A of the stage member 20, and is trained about the dancer roller 94 at the unloader 90 side. Thereafter, the leading end of the flexible substrate 100 is attached to the take-up reel 92. At this time, the leading end of the protective film 106, which is pulled-out from the feed-out reel 96, is attached to the leading end of the flexible substrate 100.

Although this work depends on the manual operation of the operator, because the PD sensor 50 is covered by the cover 52 at this time, there is no fear of a human hand contacting the PD sensor 50. Namely, because the PD sensor 50 is an extremely delicate optical system, it is apt to be disrupted by dirt. Accordingly, at the time of the work of manually attaching the flexible substrate 100 to the take-up reel 92, the PD sensor 50 is covered by the cover 52 so as to not be touched by a human hand. Further, at this time, the cleaning rollers 28 slidingly contact the flexible substrate 100. In this way, the initial image-forming region is cleaned.

When the work of attaching the flexible substrate 100 to the take-up reel 92 is completed, the stage surface 20A (the supporting body 20B) is lowered a predetermined height by the raising/lowering mechanism 20C, and the stage member 20 moves along the guide rails 16 in the return direction. At this time, because the heights of the guide rollers 18 are invariable, the guide rollers 18 contact the flexible substrate 100 from the reverse surface (bottom surface) side thereof, and support the flexible substrate 100. Accordingly, even if the flexible substrate 100 flexes, it does not contact (slidingly contact) the stage surface 20A. Note that, when the guide rollers 18 move together with the stage member 20, they are slave-rotated due to the frictional contact between the guide rollers 18 and the flexible substrate 100.

When the flexible substrate 100 is stretched in this way between the loader 80 and the unloader 90 and the stage member 20 is moved to a predetermined position and stopped, as shown in FIG. 7A, the stage surface 20A (the supporting body 20B) is raised a predetermined height by the raising/lowering mechanism 20C, and the initial image-forming region of the flexible substrate 100 is sucked to the stage surface 20A. At this time, the dancer roller 84 is at the lowered position, and the dancer roller 94 is at the raised position. Further, the guide rollers 18 are separated from the reverse surface (the bottom surface) of the flexible substrate 100.

At this time, because the PD sensor 50, which is covered by the cover 52, is disposed a predetermined height lower than the stage surface 20A, the cover 52 (the PD sensor 50) does not contact the reverse surface (bottom surface) of the flexible substrate 100. Accordingly, there is no fear that the PD sensor 50, which is a delicate optical system, will be dirtied by the flexible substrate 100. Further, at this time, the edge of the flexible substrate 100 is detected by the edge detecting sensor 48.

When the stage surface 20A of the stage member 20 sucks the image-forming region of the flexible substrate 100 in this way, in this sucking state, the stage member 20 is moved at a predetermined speed in the subscanning direction (conveying direction) along the guide rails 16, and the image-forming region of the flexible substrate 100 is conveyed in the same direction.

Then, as shown in FIG. 7B, the stage member 20 passes by the alignment section 22, and the alignment marks 102 of the flexible substrate 100 and the image-forming region in the vicinity thereof are photographed by the cameras 40. Namely, the flashes 46 are made to emit light by the flash light-emission controlling section 66, and the cameras 40 are operated by the camera operation controlling section 64.

At this time, because the edge of the flexible substrate 100 is detected by the edge detecting sensor 48, the cameras 40 are already moved to predetermined positions by the transverse direction position setting section 62. Namely, rotation of the ball screws 38 is controlled, such that the positions of the cameras 40 in the main scanning direction (the transverse direction) are adjusted.

Further, as the stage member 20 moves, the dancer roller 84 rises and the dancer roller 94 falls. The tension with respect to the flexible substrate 100 which is being conveyed is thereby adjusted so as to be constant. Moreover, at this time, the cleaning rollers 28 slidingly contact the flexible substrate 100. Therefore, the next image-forming region of the flexible substrate 100 is cleaned as the stage member 20 moves.

When the alignment marks 102 and the image-forming region in the vicinity thereof are photographed by the cameras 40, the photographed data analyzing section 68 identifies only the alignment marks 102, and this data is converted into digital image data by the alignment mark extracting section 72. Then, the alignment mark collating section 74 compares this digital image data with the reference alignment marks stored in the alignment mark data memory 70. On the basis of this comparison data and the position data obtained by the alignment mark extracting section 72, the image data correcting/computing section 76 computes position correction data for the image data to be recorded in the image-forming region.

Namely, correction factors of the exposure start position in the subscanning direction in which the stage member 20 moves, the dot shift positions in the main scanning direction and the subscanning direction of the stage member 20, and the like are computed. On the basis of these correction factors, correction ratios and the like are computed for the positional offset of the flexible substrate 100 in the transverse direction (the main scanning direction), positional offset in the conveying direction (the subscanning direction), skewing, and the like. (Note that the positional offset in the conveying direction (the subscanning direction) is shown in an exaggerated manner in FIG. 12B, and is, for example, an elongation F of about 10 μm with respect to a 500 mm length of the image-forming region in the conveying direction.)

At this time, the interval between the alignment section 22 and the exposure section 24 is greater than or equal to the length of one image-forming region in the conveying direction of the flexible substrate 100. Therefore, exposure processing does not start even when the alignment processing is completed. Namely, the alignment processing for one image-forming region is completed before the exposure processing. Accordingly, the position correction data of the image data can be computed accurately (the image data can be corrected accurately).

When the photographing of the alignment marks 102 by the alignment section 22 is completed, the stage member 20 is stopped temporarily. During this time when the stage member 20 is stopped, the aforementioned position correction data is computed, and the image data to be exposed at the exposure section 24 is corrected on the basis of this computed position correction data. Note that, when the stage member 20 passes by the alignment section 22, the cleaning rollers 28 move away from the flexible substrate 100.

Thereafter, as shown in FIG. 7C, with the flexible substrate 100 remaining sucked thereto, the stage member 20 is moved further in the subscanning direction at a predetermined speed, and passes by the exposure section 24. Namely, in the exposure section 24, the light beams, which are modulated by the DMDs which are turned on and off on the basis of the corrected image data, are irradiated from the exposure heads 30 and focused, and expose the image-forming region of the flexible substrate 100.

Accordingly, the desired image is formed (recorded) accurately in the image-forming region of the flexible substrate 100. Note that the movement of the stage member 20 may be started before the correcting of the image data is completed. Further, as the stage member 20 moves, the dancer roller 84 rises further and the dancer roller 94 falls further. The tension with respect to the flexible substrate 100 which is being conveyed is thereby adjusted so as to be constant.

When the image has been formed (recorded) in the image-forming region of the flexible substrate 100 by the exposure heads 30, the stage member 20 is again stopped temporarily. Then, as shown in FIG. 7D, the stage member 20 moves in the return direction with the flexible substrate 100 remaining sucked thereto, and stops again at a position between the alignment section 22 and the exposure section 24. At this time, the dancer roller 84 falls and stops at a predetermined position, and the dancer roller 94 rises and stops at a predetermined position.

When the stage member 20 stops at the aforementioned position, the stage surface 20A thereof releases the sucking of the flexible substrate 100 and is lowered a predetermined height by the raising/lowering mechanism 20C. Then, as shown in FIG. 7E, the stage member 20 moves further in the return direction, and again stops at a predetermined position at which the next image-forming region can be sucked.

At this time, the heights of the guide rollers 18, which are provided at the both sides of the stage member 20, are invariable. Therefore, the guide rollers 18 support the flexible substrate 100 from the reverse surface (bottom surface) side thereof. Accordingly, even if the flexible substrate 100 flexes, it does not contact (slidingly contact) the stage surface 20A. Further, because the guide rollers 18 are frictionally contacting the reverse surface (bottom surface) of the flexible substrate 100, they move while being slave-rotated as the stage member 20 moves.

When the stage member 20 again stops at a predetermined position where the next image-forming region is to be sucked, the stage surface 20A thereof is raised a predetermined height by the raising/lowering mechanism 20C, and the reverse surface (bottom surface) of the flexible substrate 100 where the next image-forming region exists is sucked and held to the stage surface 20A. After the stage surface 20A sucks and holds the flexible substrate 100, the unexposed flexible substrate 100 is pulled-out due to the supply reel 82 rotating, and the dancer roller 84 falls.

When the dancer roller 84 reaches a predetermined lower position, a sensor (not shown) turns on, and the rotational driving of the supply reel 82 thereby stops. Further, the take-up reel 92 takes-up the flexible substrate 100, and accompanying this operation of taking-up, the dancer roller 94 rises. Then, the cleaning rollers 28 slidingly contact the flexible substrate 100.

In this way, the operations of FIGS. 7A through 7E are carried out again, and by repeatedly carrying out these operations, images are successively formed (recorded) on the image-forming regions of the flexible substrate 100. In accordance with such a structure, the exposed image-forming regions of the flexible substrate 100 can be conveyed (discharged) by the stage member 20. Therefore, there is the effect that it suffices to not provide a separate mechanism for conveying (discharging) the flexible substrate 100 each image-forming region.

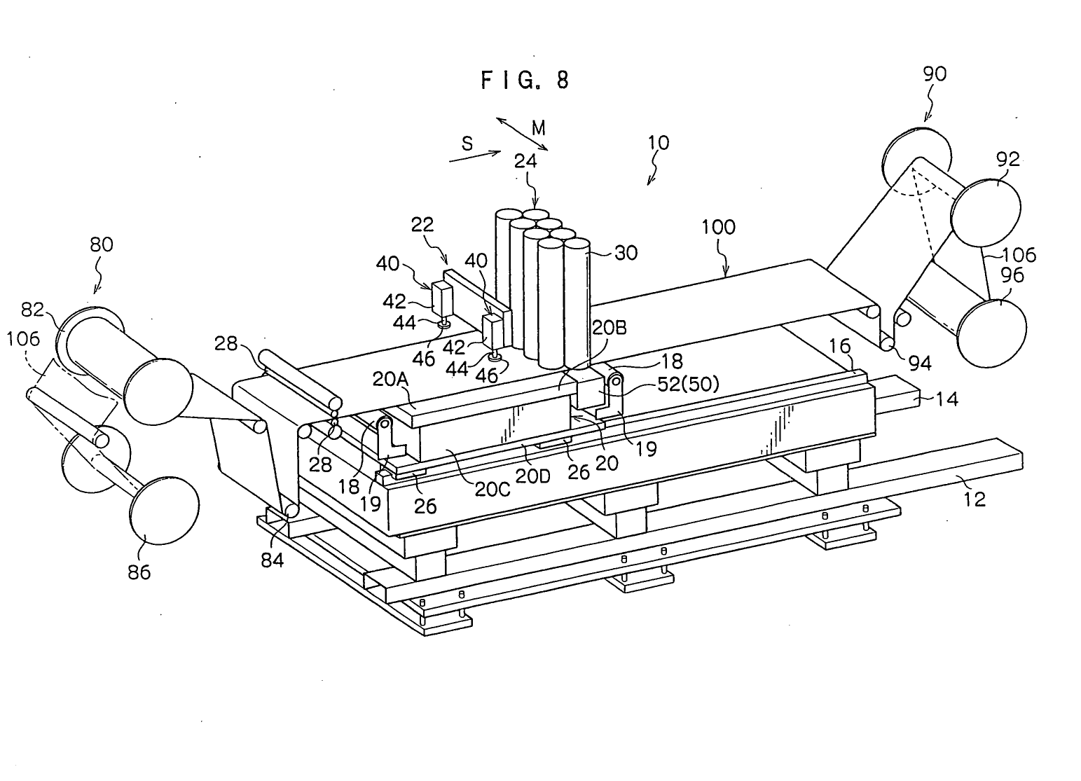

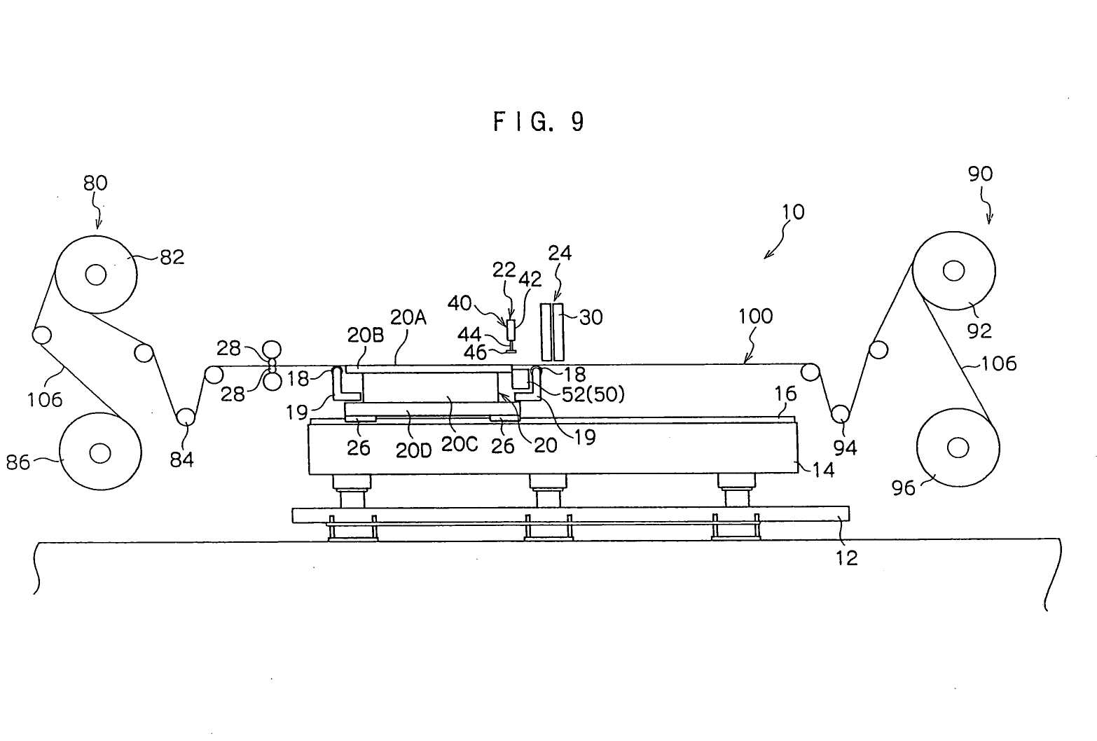

Next, a modified example of the image recording device 10 shown in FIGS. 8, 9, and 10A through 10F will be described. The image recording device 10 shown in FIGS. 8 and 9 differs from the above-described embodiment only with respect to the point that the interval between the alignment section 22 and the exposure section 24 is less than the length of one image-forming region in the conveying direction of the flexible substrate 100, i.e., the alignment section 22 and the exposure section 24 are disposed close to one another.

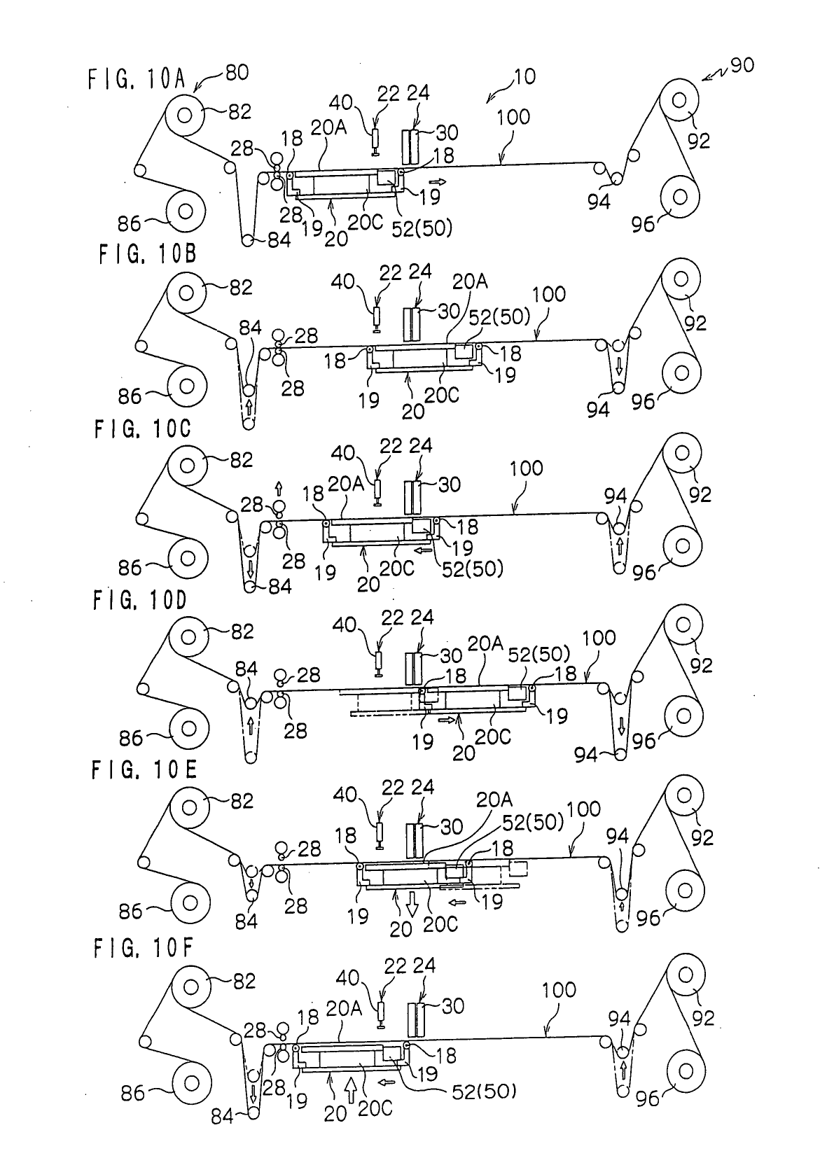

With such a structure, the stage member 20 must be moved in the return direction once before the exposure processing. However; there is the effect that the subscanning direction (conveying direction) length of the image recording device 10 can be structured to be shorter than in the above-described embodiment. Namely, the image recording device 10 itself can be made compact. Operation thereof will be described hereinafter on the basis of FIGS. 10A though 10F, but contents which are the same as those described above will be omitted appropriately.

When the cleaning rollers 28 have cleaned the image-forming region of the flexible substrate 100 stretched between the loader 80 and the unloader 90, as shown in FIG. 10A, the stage surface 20A (the supporting body 20B) is raised a predetermined height by the raising/lowering mechanism 20C, the stage surface 20A sucks the image-forming region of the flexible substrate 100, and the guide rollers 18 separate from the reverse surface (bottom surface) of the flexible substrate 100. Note that, at this time, the dancer roller 84 is at the lowered position, and the dancer roller 94 is at the raised position.

Further, at this time, because the PD sensor 50 which is covered by the cover 52 is disposed a predetermined height lower than the stage surface 20A, the cover 52 (the PD sensor 50) does not contact the reverse surface (bottom surface) of the flexible substrate 100. Accordingly, there is no fear that the PD sensor 50, which is a delicate optical system, will be dirtied by the flexible substrate 100. Further, at this time, the edge of the flexible substrate 100 is detected by the edge detecting sensor 48.

When the stage surface 20A of the stage member 20 sucks the image-forming region of the flexible substrate 100 in this way, in this sucking state, the stage member 20 is moved at a predetermined speed in the subscanning direction (conveying direction) along the guide rails 16, and the image-forming region of the flexible substrate 100 is conveyed in the same direction.

Then, as shown in FIG. 10B, the stage member 20 passes by the alignment section 22, and the alignment marks 102 of the flexible substrate 100 and the image-forming region in the vicinity thereof are photographed by the cameras 40. Namely, the flashes 46 are made to emit light by the flash light-emission controlling section 66, and the cameras 40 are operated by the camera operation controlling section 64.

At this time, because the edge of the flexible substrate 100 is detected by the edge detecting sensor 48, the cameras 40 are already moved to predetermined positions by the transverse direction position setting section 62. Namely, rotation of the ball screws 38 is controlled, such that the positions of the cameras 40 in the main scanning direction (the transverse direction) are adjusted.

Further, as the stage member 20 moves, the dancer roller 84 rises and the dancer roller 94 falls. The tension with respect to the flexible substrate 100 which is being conveyed is thereby adjusted so as to be constant. Moreover, at this time, the cleaning rollers 28 slidingly contact the flexible substrate 100. Therefore, the next image-forming region of the flexible substrate 100 is cleaned as the stage member 20 moves.

When the alignment marks 102 and the image-forming region in the vicinity thereof are photographed by the cameras 40, the photographed data analyzing section 68 identifies only the alignment marks 102, and this data is converted into digital image data by the alignment mark extracting section 72. Then, the alignment mark collating section 74 compares this digital image data with the reference alignment marks stored in the alignment mark data memory 70. On the basis of this comparison data and the position data obtained by the alignment mark extracting section 72, the image data correcting/computing section 76 computes position correction data for the image data to be recorded in the image-forming region.

Namely, correction factors of the exposure start position in the subscanning direction in which the stage member 20 moves, the dot shift positions in the main scanning direction and the subscanning direction of the stage member 20, and the like are computed. On the basis of these correction factors, correction ratios and the like are computed for the positional offset of the flexible substrate 100 in the transverse direction (the main scanning direction), positional offset in the conveying direction (the subscanning direction), skewing, and the like. (The positional offset in the conveying direction (the subscanning direction) is shown in an exaggerated manner in FIG. 12B, and is, for example, the elongation F of about 10 μl with respect to a 500 mm length of the image-forming region in the conveying direction.)

When the photographing of the alignment marks 102 by the alignment section 22 is completed, the stage member 20 is stopped temporarily, and as shown in FIG. 10C, the cleaning rollers 28 move away from the flexible substrate 100. Then, the stage member 20 moves in the return direction, and leading-end-positioning with respect to the exposure section 24 is carried out. Namely, the leading end of the image-forming region is positioned with respect to the exposure heads 30. Then, during this movement, the aforementioned position correction data is computed, and the image data to be exposed at the exposure section 24 is corrected on the basis of this computed position correction data.

Accordingly, even in a structure in which the stage member 20 moves once in the return direction for the leading-end-positioning with respect to the exposure section 24, the tact time for processing one image-forming region by the stage member 20, which moves at the same speed as in the above-described embodiment, does not change. Namely, the time over which the stage member 20 is stopped in the above-described embodiment, and the moving time until the stage member 20 is leading-end positioned in the present modified example, are the same.

Further, in the present modified example as well, because the alignment processing for one image-forming region is completed before exposure processing, the position correction data of the image data can be computed accurately (the image data can be corrected accurately). Further, as the stage member moves for leading-end-positioning, the dancer roller 84 falls and the dancer roller 94 rises. The tension with respect to the flexible substrate 100 which is being conveyed is thereby adjusted so as to be constant.

Thereafter, as shown in FIG. 10D, with the flexible substrate 100 remaining sucked thereto, the stage member 20 moves at a predetermined speed in the subscanning direction, and passes by the exposure section 24. Namely, in the exposure section 24, the light beams, which are modulated by the DMDs which are turned on and off on the basis of the corrected image data, are irradiated from the exposure heads 30 and focused, and expose the image-forming region of the flexible substrate 100.

Accordingly, the desired image is formed (recorded) accurately in the image-forming region of the flexible substrate 100. Note that the movement of the stage member 20 may be started before the correcting of the image data is completed. Further, as the stage member 20 moves, the dancer roller 84 rises and the dancer roller 94 falls. The tension with respect to the flexible substrate 100 which is being conveyed is thereby adjusted so as to be constant.

When the image has been formed (recorded) in the image-forming region of the flexible substrate 100 by the exposure heads 30, the stage member 20 is again stopped temporarily. At this time, as shown in FIG. 10E, the stage member 20 moves in the return direction with the flexible substrate 100 remaining sucked thereto, and is stopped at a predetermined position. At this time, the dancer roller 84 falls and stops at a predetermined position, and the dancer roller 94 rises and stops at a predetermined position.

When the stage member 20 stops at the aforementioned predetermined position, the stage surface 20A of the stage member 20 releases the sucking of the flexible substrate 100, and is lowered a predetermined height by the raising/lowering mechanism 20C. Then, as shown in FIG. 10F, the stage member 20 moves further in the return direction, and is again stopped at a predetermined position where the next image-forming region can be sucked.

At this time, because the heights of the guide rollers 18 provided at the both sides of the stage member 20 are invariable, the guide rollers 18 support the flexible substrate 100 from the reverse surface (bottom surface) side thereof. Accordingly, even if the flexible substrate 100 flexes, it does not contact (slidingly contact) the stage surface 20A. Further, because the guide rollers 18 frictionally contact the reverse surface (bottom surface) of the flexible substrate 100, they move while being slave-rotated as the stage member 20 moves.

Then, when the stage member 20 is again stopped at the predetermined position at which it sucks the next image-forming region, as shown in FIG. 10F, the stage member 20A is raised a predetermined height by the raising/lowering mechanism 20C, and the reverse surface (bottom surface) of the flexible substrate 100 where the next image-forming region exists is sucked and held to the stage surface 20A of the stage member 20. When the stage surface 20A sucks and holds the flexible substrate 100, the unexposed flexible substrate 100 is pulled-out due to the supply reel 82 rotating, and the dancer roller 84 falls.

When the dancer roller 84 reaches a predetermined lower position, a sensor (not shown) turns on, and the rotational driving of the supply reel 82 thereby stops. Further, the take-up reel 92 takes-up the flexible substrate 100, and accompanying this operation of taking-up, the dancer roller 94 rises. Then, the cleaning rollers 28 slidingly contact the flexible substrate 100.

In this way, the operations of FIGS. 10A through 10F are carried out again, and by repeatedly carrying out these operations, images are successively formed (recorded) on the image-forming regions of the flexible substrate 100. In accordance with such a structure, the exposed image-forming regions of the flexible substrate 100 can be conveyed (discharged) by the stage member 20. Therefore, there is the effect that it suffices to not provide a separate mechanism for conveying (discharging) the flexible substrate 100 each image-forming region.

In either case, because the flexible substrate 100 is sucked and conveyed by the stage member 20, the occurrence of skewing and wrinkles can be prevented, and highly accurate conveying can be realized. Further, at one image-forming region, the alignment processing can be completed before the image recording processing. Therefore, the image data can be corrected accurately. Accordingly, the desired image can be recorded accurately on the flexible substrate 100.

Namely, after an entire, one image-forming region of the flexible substrate 100 is confirmed ahead by the alignment section 22, the position correction data is computed, and exposure is carried out with the image data corrected on the basis of this computed position correction data. Therefore, the accuracy of exposure can be improved. Accordingly, it is possible to carry out exposure while addressing not only skewing of the flexible substrate 100, but also positional offset (the elongation F) of the flexible substrate 100 in the conveying direction (the subscanning direction). The product quality and reliability can be improved.

In the above-described embodiment, explanation is given of a case in which DMDs serve as spatial light modulators. However, other than such a reflecting-type spatial light modulator, a transmitting-type spatial light modulator (LCD) can be used. For example, a MEMS (Micro Electro Mechanical System) type spatial light modulator (SLM), or a spatial light modulator other than a MEMS type, such as an optical element which modulates transmitted light in accordance with the electrooptical effect (a PLZT element), or a liquid crystal shutter array like a liquid crystal light shutter (FLC), or the like may be used.

Note that “MEMS” collectively refers to minute systems in which micro-sized sensors, actuators and control circuits, which are formed by micromachining techniques based on IC manufacturing processes, are integrated. A MEMS type spatial light modulator means a spatial light modulator which is driven by electromechanical operation using static electricity. Moreover, a structure in which a plurality of grating light valves (GLVs) are lined-up in a two-dimensional form can be used. In structures using reflecting-type spatial light modulators (GLVs) and transmitting-type spatial light modulators (LCDs), a lamp or the like can be used as the light source, rather than the aforementioned laser.

A fiber array light source having a plurality of multiplex laser light sources; a fiber array light source in which fiber light sources, each of which has one optical fiber from which exits laser light which is incident from a single semiconductor laser having one light-emitting point, are set in the form of an array; a light source in which a plurality of light-emitting points are arranged in two dimensions (e.g., an LD array, an organic EL array, and the like); or the like can be used as the light source in the above-described embodiment. Further, the above-described embodiment is structured such that images are recorded by using the exposure heads 30, but the same holds for structures in which images are recorded by using inkjet recording heads (not illustrated).

1. An image recording device recording an image on an image-forming region of a strip-shaped flexible substrate stretched between a supply reel and a take-up reel, the device comprising:
a stage section structured so as to be able to suction the flexible substrate, and so as to be movable along a predetermined conveying path;
an alignment section disposed above the conveying path of the stage section, and sensing at least an alignment mark of the flexible substrate;
a correcting section which, on the basis of the alignment mark sensed by the alignment section, corrects image data to be recorded on the image-forming region of the flexible substrate; and
a recording section disposed above the conveying path of the stage section and at a downstream side, in a conveying direction of the flexible substrate, of the alignment section, the recording section recording, on the image-forming region of the flexible substrate, the image data corrected by the correcting section.

2. The image recording device of claim 1, wherein an interval between the alignment section and the recording section is greater than or equal to a length of one image-forming region in the conveying direction of the flexible substrate.

3. The image recording device of claim 1, wherein an interval between the alignment section and the recording section is less than a length of one image-forming region in the conveying direction of the flexible substrate, and after the alignment section senses the alignment mark, the stage section moves a predetermined distance in a direction opposite to the conveying direction, and leading-end-positioning of the stage section with respect to the recording section is carried out.

4. The image recording device of claim 1, wherein the correcting section computes a correction amount at least with respect to the conveying direction of the flexible substrate.

5. The image recording device of claim 2, wherein the correcting section computes a correction amount at least with respect to the conveying direction of the flexible substrate.

6. The image recording device of claim 3, wherein the correcting section computes a correction amount at least with respect to the conveying direction of the flexible substrate.

7. The image recording device of claim 1, wherein the flexible substrate is conveyed-in and discharged-out with the image-forming region of the flexible substrate suctioned to the stage section.

8. The image recording device of claim 1, wherein the recording section has an exposure head which exposes the flexible substrate and records the image data.

9. The image recording device of claim 8, wherein the exposure head irradiates a light beam, which is modulated on the basis of the image data, and exposes the flexible substrate.

10. An image recording method recording an image on an image-forming region of a strip-shaped flexible substrate stretched between a supply reel and a take-up reel, the method comprising:
moving, along a predetermined conveying path, a stage section which suctions the flexible substrate;
sensing, by an alignment section, at least an alignment mark of the flexible substrate;
on the basis of the sensed alignment mark, correcting, by a correcting section, image data to be recorded on the image-forming region of the flexible substrate; and
recording, by a recording section, corrected image data on the image-forming region of the flexible substrate.

11. The image recording method of claim 10, wherein an interval between the alignment section and the recording section is greater than or equal to a length of one image-forming region in a conveying direction of the flexible substrate, and
after the alignment section senses the alignment mark, the stage section stops once, the correcting section computes a correction amount, and image recording is started while the stage section moves to the recording section.

12. The image recording method of claim 10, wherein an interval between the alignment section and the recording section is less than a length of one image-forming region in a conveying direction of the flexible substrate, and
after the alignment section senses the alignment mark, the stage section moves a predetermined distance in a direction opposite to the conveying direction, leading-end-positioning of the stage section with respect to the recording section is carried out, the correcting section computes a correction amount, and image recording is started while the stage section moves to the recording section.

13. The image recording method of claim 10, wherein the correcting section computes a correction amount at least with respect to a conveying direction of the flexible substrate.

14. The image recording method of claim 11, wherein the correcting section computes a correction amount at least with respect to a conveying direction of the flexible substrate.

15. The image recording method of claim 12, wherein the correcting section computes a correction amount at least with respect to a conveying direction of the flexible substrate.

16. The image recording method of claim 10, wherein the flexible substrate is conveyed-in and discharged-out with the image-forming region of the flexible substrate suctioned to the stage section.

17. The image recording method of claim 10, wherein the recording section has an exposure head which exposes the flexible substrate and records the image data.

18. The image recording method of claim 17, wherein the exposure head irradiates a light beam, which is modulated on the basis of the image data, and exposes the flexible substrate.
